(19) United States
(12) Patent Application Publication
(10) Pub. No.: US 2003/0099851 A1
(43) Pub. Date: May 29, 2003

(54) Multilayer metallized film having enhanced barrier and metal adhesion characteristics

(76) Inventors: Eldridge M. Mount III, Fairport, NY (US); Francis Tran, Cumming, GA (US); John A. Larter, Canandaigua, NY (US)

Correspondence Address: ExxonMobil Chemical Company, Law Technology, P.O. Box 2149, Baytown, TX, 77522-2149, US

(21) Appl. No.: 09/729,809

(22) Filed: Dec. 5, 2000

(51) Int. Cl. B32B 15/08

(52) U.S. Cl. 428/476.1; 428/516; 428/520; 428/458; 428/463; 428/910; 264/173.14; 264/173.19; 427/250

(57) ABSTRACT

Polyolefin films having excellent barrier and metal adhesion characteristics and methods for producing the same are provided. The polyolefin film structures include a polyolefin core layer having a first and second side, a heat sealable layer adjacent to the first side of the core layer and substantially coextensive therewith, and a high barrier layer adjacent to the second side of the core layer and substantially coextensive therewith. The high barrier layer includes a blend of ethylene vinyl alcohol copolymer and nylon. Preferred embodiments of the present invention also provide for a metallized skin layer adjacent to the high barrier layer and substantially coextensive therewith.

### BACKGROUND OF THE INVENTION

The present invention relates to polymer film structures and methods of preparing polymer film structures. Specifically, the present invention relates to multilayer metallized packaging film structures having enhanced barrier and metal adhesion characteristics and methods of preparing the same.

Generally, in the preparation of a film from granular or pelleted polymer resin, the polymer is first extruded to provide a stream of polymer melt, and then the extruded polymer is subjected to the film-making process. Film-making typically involves a number of discrete procedural stages including melt film formation, quenching and windup. For a general description of these and other processes associated with film-making, see K R Osborn and W A Jenkins, Plastic Films: Technology and Packaging Applications, Technomic Publishing Co., Inc., Lancaster, Pa. (1992).

An optional part of the film-making process is a procedure known as “orientation.” The “orientation” of a polymer is a reference to its molecular organization, i.e., the orientation of molecules relative to each other. Similarly, the process of “orientation” is the process by which directionality (orientation) is imposed upon the polymeric arrangements in the film. The process of orientation is employed to impart desirable properties to films, including making cast films tougher (higher tensile properties). Depending on whether the film is made by casting as a flat film or by blowing as a tubular film, the orientation process requires substantially different procedures. This is related to the different physical characteristics possessed by films made by the two conventional film-making processes: casting and blowing. Generally, blown films tend to have greater stiffness and toughness. By contrast, cast films usually have the advantages of greater film clarity and uniformity of thickness and flatness, generally permitting use of a wider range of polymers and producing a higher quality film.

Orientation is accomplished by heating a polymer to a temperature at or above its glass-transition temperature (T_{g}) but below its crystalline melting point (Tₘ), and then stretching the film, preferably quickly. On cooling, the freezing of molecular alignment imposed by the stretching competes favorably with crystallization and the drawn polymer molecules form an amorphous polymer network with crystalline domains (crystallites) aligned in the direction of the drawing force. As a general rule, the degree of orientation is proportional to the amount of stretch and inversely related to the temperature at which the stretching is performed. For example, if a base material is stretched to twice its original length (2:1) at a higher temperature, the orientation in the resulting film will tend to be less than that in another film stretched 2:1 but at a lower temperature. Moreover, higher orientation also generally correlates with a higher modulus, i.e., measurably higher stiffness and strength. Further, as a general rule, higher orientation correlates with films having improved gloss and haze characteristics in the absence of cavitation.

Biaxial orientation is employed to more evenly distribute the strength qualities of the film in two directions. Biaxially oriented films tend to be stiffer and stronger, and also exhibit much better resistance to flexing or folding forces, leading to their greater utility in packaging applications.

Most biaxial orientation processes involve apparatus which stretches the film sequentially, first in one direction and then in the other. Tenter frame orienting apparatus stretches the film first in the direction of the film travel, i.e., in the longitudinal or “machine direction” (MD), and then in the direction perpendicular to the machine direction, i.e., the lateral or “transverse direction” (TD).

The degree to which a film can be oriented is dependent upon the polymer from which it is made. Polypropylene, polyethylene terephthalate (PET), and nylon are highly crystalline polymers that are readily heat stabilized to form dimensionally stable films. These films are well known to be capable of being biaxially stretched to many times the dimensions in which they are originally cast (e.g., 5X by 8X or more for polypropylene).

The film-making process can also include extrusion coating a film to impart superior characteristics to the film and methods of extrusion coating are well known in the art. Most known methods provide for extrusion coating a film after it has been biaxially oriented. The barrier properties of films prepared according to these known methods can be improved.

The film-making process can also include metallization to obtain a metal-like appearance and to enhance the barrier characteristics of a film.

The present invention is directed to film structures which are biaxially oriented and are produced by coextrusion and/or extrusion coating processes. The films of the present invention can be widely used in food packaging applications due to their superior barrier properties as films utilized in food packaging must be as resistant as possible to the transmission of moisture, air and deleterious flavors.

Attempts have been made in the past to provide metallized films which have enhanced moisture and oxygen barrier characteristics. For example, U.S. Pat. No. 5,591,520 to Migliorini discloses a metallized multilayer film structure including a base layer of polypropylene homopolymer or copolymer having at least a surface of maleic anhydride polypropylene on which there is a skin layer of an amorphous polyamide or a blend of an amorphous polyamide and a semicrystalline polyamide to which a metallized layer can be bonded.

However, unmodified functional polymer skins of high barrier films are expensive and typically exhibit process defects such as die build up, adhesion problems to the core, poor stretching or end use defects such as poor metal adhesion and inconsistent barrier. More recently, the end use problems of metallized film technology have been improved by applying a 100% EVOH layer to the metallized skin. Nevertheless, the high barrier skin technology available in the art requires high material cost and has process defects that still need to be solved. Thus, there is still a need in the art of packaging films which have excellent oxygen, flavor/odor, moisture barrier characteristics in addition to other properties which enhance the fitness for making packaging films.

Accordingly, it is one of the purposes of the present invention, among others, to provide new packaging film structures which have excellent moisture and oxygen barrier, good metal adhesion and good processability properties such as thermal stability, reduced gels, high stretch range and low die build up.

### SUMMARY OF THE INVENTION

The present invention provides for a multilayer packaging film structure including a polyolefin core layer having a first and second side, a heat sealable layer adjacent to the first side of the core layer and substantially coextensive therewith, and a high barrier layer adjacent to the second side of the core layer and substantially coextensive therewith. The high barrier layer includes a blend of ethylene vinyl alcohol copolymer and nylon. The multilayer film structure has enhanced barrier and metal adhesion characteristics.

Preferably, the heat sealable layer includes a sealant selected from the group consisting of homopolymers, copolymers, terpolymers and mixtures thereof It is also preferable that the heat sealable layer include a non-migrating antiblock and/or a slip agent.

The high barrier layer preferably includes from about 55% by weight to about 70% by weight of ethylene vinyl copolymer and from about 30% by weight to about 45% by weight of nylon.

In a preferred embodiment, the multilayer film structure of the present invention further includes a polyolefin tie resin layer between the core layer and the high barrier layer. Preferably, the polyolefin tie resin layer includes a tie resin selected from the group consisting of anhydride polyolefins; Mitsui 7911; DuPont's Bynel 50E571, Bynel 50E622 and Bynel 3800 Series; Millennium's PX 5518, PX 209 and PX 380; and Uniroyal 3200.

Another preferred embodiment of the present invention provides for a multilayer packaging film structure including a polyolefin core layer having a first and second side, a heat sealable layer adjacent to the first side of the core layer and substantially coextensive therewith, a high barrier layer adjacent to the second side of the core layer and substantially coextensive therewith, and a metallized skin layer adjacent to the high barrier layer and substantially coextensive therewith. The high barrier layer includes a blend of ethylene vinyl alcohol copolymer and nylon. The multilayer film structure has enhanced barrier and metal adhesion characteristics.

The present invention also provides for a method for preparing a multilayer film structure having enhanced barrier and metal adhesion characteristics including: orienting in the machine direction a coextruded film structure which has a polyolefin core layer having a first and a second side, a heat sealable layer adjacent to the first side of the core layer and substantially coextensive therewith, and a tie resin layer deposited on the second side of the core layer and substantially coextensive therewith, coextruding or extrusion coating a high barrier layer on the tie resin layer of the second side of the core layer; orienting the film structure in the transverse direction; and metallizing the high barrier layer by vapor deposition or extrusion lamination.

The high barrier layer preferably includes from about 55% by weight to about 70% by weight of ethylene vinyl copolymer and from about 30% by weight to about 45% by weight of nylon. Further, it is preferable that the tie resin layer is corona treated prior to coextruding or extrusion coating a high barrier on the tie resin layer.

As a result of the present invention, packaging film structures are provided which have excellent oxygen, flavor/odor and moisture barrier, and good metal adhesion. Additionally, by applying a layer containing a blend of EVOH and nylon, packaging film structures having high thermal stability, reduced gels, high stretch range, consistent gel control and low die build up are obtained. Moreover, manufacturing applications with the film structure of the present invention have high up-times and low processing costs.

These and other advantages of the present invention will be appreciated from the detailed description and examples which are set forth herein. The detailed description and examples enhance the understanding of the invention, but are not intended to limit the scope of the invention.

### BRIEF DESCRIPTION OF THE DRAWINGS

A preferred embodiment of the present invention has been chosen for purposes of illustration and description, but is not intended in any way to restrict the scope of the invention. The preferred embodiment of certain aspects of the invention is shown in the accompanying drawing, wherein:

FIG. 1. illustrates a cross-sectional view of an embodiment of the present invention.

### DETAILED DESCRIPTION OF THE INVENTION

The present invention provides for multilayer film structures having excellent oxygen and moisture barrier, and good metal adhesion. Multilayer film structures of the present invention include a core layer of a lower olefinic polymer such as polyethylene or polypropylene. In particular, the polyolefin is probably a homopolymer or copolymer of propylene, low density polyethylene (“LDPE”) or linear low density polyethylene (“LLDPE”). The core layer can alternatively include high density polyethylene (“HDPE”).

The term “low density polyethylene” (LDPE) as used herein is defined to mean an ethylene-containing polymer having a density of about 0.926 or lower and a melt index (MI) of about 7. (Melt Index is expressed as g/10 min.) (Density (d) is expressed as g/cm³.) LDPE is readily available, e.g., PE 1017 (MI=7; d=0.917) from Chevron, San Francisco, Calif., SLP 9045 (MI=7.5; d=0.908) from Exxon, Houston, Tex., and ZCE 200 (MI=3; d=0.918) from Mobil Chemical Corporation, Fairfax, Va.

The term “linear low density polyethylene” (LLDPE) as used herein is defined to mean a copolymer of ethylene and a minor amount of an olefin containing 4 to 10 carbon atoms, having a density of from about 0.910 to about 0.926 and a MI of from about 0.5 to about 10. LLDPE is readily available, e.g., Dowlex™ 2045.03 (MI=1.1; d=0.920) from Dow Chemical Company, Midland, Mich.

The term “high density polyethylene” (HDPE) as used herein is defined to mean an ethylene-containing polymer having a density of 0.940 or higher. One particularly suitable HDPE for use with the present invention is the resin sold as M6211 (d=0.958) by Equistar. Another particularly suitable HDPE is the resin sold as HD 7845.30 (d=0.958) by Exxon. Other suitable HDPE resins include, for example, BDM 94-25 (d=0.961) and 6573 XHC (d=0.959) which are both available from Fina Oil and Chemical Co., Dallas, Tex. and Sclair 19C (d=0.951) and 19F (d=0.961) which are both available from Nova Corporation, Sarnia, Ontario, Canada.

The melt index of the HDPE useful according to the invention is in the range of from about 0.05 to about 6.0. Preferably, the HDPE has a melt index in the range of from about 0.3 to about 3.0. Melt index is generally understood to be inversely related to viscosity, and decreases as molecular weight increases. Accordingly, higher molecular weight HDPE generally has a lower melt index. Methods for determining melt index are known in the art, e.g., ASTM D 1238.

The films of the present invention also include a heat sealable layer which can include a non-migratory antiblock and/or slip agent that can be extruded or coextruded on one surface of the core layer. The heat sealable layer includes a sealant and useful sealants include homopolymers, copolymers, terpolymers or mixtures thereof When extruded or coextruded with the core polyolefin layer and the remaining layers of the film structure of the present invention, the heat sealant layer functions to impart strong heat sealable properties to the entire structure.

The homopolymer contemplated herein is formed by polymerizing the respective monomer. This can be accomplished by bulk or solution.

The copolymer contemplated herein can be selected from those copolymers typically employed in the manufacture of multilayered films. For instance, an ethylene-propylene random copolymer which is formed by the simultaneous polymerization of the respective monomers can be used to form the heat sealable layer. Effective formation of a random copolymer of ethylene and propylene is accomplished when the ethylene is present simultaneously with the propylene in an amount sufficient to result in from 0.5 to 10 wt % ethylene in the resulting copolymer. This system is characterized by random placement of the respective monomer units along the polymer chain. This is in contrast to a block copolymer of ethylene and propylene formed by sequential polymerization of the respective monomers. The feeding of the monomers in forming a block copolymer is controlled so that the monomer employed in one stage of the sequential polymerization is not added until the monomer employed in the preceding stage has been at least substantially consumed thereby insuring that the concentration of the monomer remaining from that preceding stage is sufficiently low to prevent formation of an excessive proportion of random copolymer.

The contemplated terpolymers are comparatively low stereoregular polymers. The terpolymers can have a melt flow rate at 446° F. ranging from 2 to 10 grams per 10 minutes and preferably from 4 to 6 grams per 10 minutes. The crystalline melting point can range from less than 250° F. The terpolymers will predominate in propylene, and the ethylene and 1-butene monomers can be present in approximately from 0.3:1-1:1 mole percentage in relation to each other.

Commercially available heat sealants that can be used in the process of making the film structures of the present invention include Fina 9421 containing a loading of 2300 Shin-Etsug® 1186 and 1000 ppm Sylobloc® 44, and Chisso 7823 containing a loading of 2300 ppm Tospearl 130 and 1000 ppm Sylobloc® 44. Non-migrating antiblock agents such as amorphous silica, syloid, Sylobloc® 44 and crosslinked silacane spheres such as Tospearl 130 and Shin-Etsu 1186, and/or slip agents such as erucamide, stearamide and oleramide can be included in the heat sealable layer.

Adjacent to the other side of the polyolefin core layer is what is referred to herein as a “high barrier layer” which has a thickness of 3-5 gauges and includes a blend of ethylene vinyl alcohol copolymers (EVOH) and nylon.

EVOH refers to ethylene vinyl alcohol copolymers which are well known to exhibit good oxygen barrier properties. Such ethylene vinyl alcohol copolymers have been described in many patents including U.S. Pat. Nos. 3,975,463 and 4,468,427, which are both incorporated herein by reference thereto. The high barrier layer preferably includes from about 55% by weight to about 70% by weight of EVOH copolymer containing from about 27% by weight to 47% by weight of ethylene comonomer. Commercially available EVOH that can be used to prepare the high barrier layer of the present invention include EVAL® G156B, F104 or L101 which can be obtained from EVALCA.

The high barrier layer also preferably includes nylon in an amount from about 30% by weight to about 45% by weight. Nylon refers to a polymer produced by DuPont Co., specifically, PAUX-2034. Nylon PAUX-2034 is amorphous and contains a proprietary gel minimizing control chemical which controls the free acid level of nylon to less than 100 milliequivalents/gram of nylon. Not all types of amorphous nylon have this chemical, for example, Selar 3426 does not.

Typically, in order to adhere the high barrier layer to the polyolefin core layer, a tie resin layer is employed. The tie resin layer includes a tie resin, and the tie resin can be an anhydride polyolefin such as maleic anhydride. Several commercially available tie resins which can be used with the present invention include Mitsui 7911; Dupont's Bynel 50E571, Bynel 50E662 and Bynel 3800 series; PX 5518, PX209 and PX 380 which are available from Millenium; and Uniroyal 3200.

Further, it has been found advantageous to treat the tie resin layer of the film structure of the present invention prior to receiving the metallized layer. Such treatment enhances the adhesion of the metallized layer. A preferred treatment involves treating the surface to a surface tension level of at least about 35 dynes/cm and preferably from 38 to 45 dynes/cm in accordance with ASTM Standard D2578-84. The treatment can be flame treatment, plasma treatment, chemical treatment or corona discharge treatment. Flame treatment and corona discharge treatment are preferred, and corona discharge treatment is most preferred.

In the film structures of the present invention, it is preferred that the high barrier layer which includes a blend of EVOH and nylon carry a metallized skin layer such as an aluminum layer. Metallization, which occurs directly on the high barrier layer, is accomplished by conventional vacuum deposition. While aluminum is illustrated as the preferred metal, it is to be understood that other metals such as zinc, gold, etc., which are capable of being commercially vapor deposited, can also be employed. While propylene can be used as the laminate film to the surface of the metal layer, this is merely by way of illustration and it is to be understood that other films such as polyolefins, i.e., polyethylene, (particularly, high density polyethylene), polybutylene, olefin copolymers, polyamides, polycarbonate, polyacrylonitrile, etc., can also be employed The resulting multilayer film structures of the present invention have excellent processability and “fitness for make” properties. As used herein “fitness for make” refers to properties of the film structure which render the film structure easy to manufacture. Such properties include thermal stability, reduced gels, high stretch range and low die build-up.

The present invention also provides a method of preparing the multilayer film structure described above. The multilayer film structures of the present invention are produced by coextrusion and/or extrusion coating technology. The total thickness of the multilayer film structures using either technology is 0.70 mil (1 mil=0.001 inch).

A preferred method of making a multilayer film structure of the present invention includes the following steps:

(a) orienting in the machine direction a coextruded film structure including a polyolefin core layer having a first and a second side, a heat sealable layer adjacent the first side of the core layer and a tie resin layer adjacent the second side of the core layer;

(b) extrusion coating a high barrier layer on the tie resin layer of the film structure resulting from step (a);

(c) orienting the film structure from step (b) in the transverse direction;

and

(d) attaching a metallized layer to the resin layer of the resulting structure of step (c) by vapor deposition or extrusion lamination.

A multilayer film structure formed following steps (a) and (b) is shown in FIG. 1. Layer 10 represents a heat sealable layer. Layer 11 represents a polyolefin core layer. Layer 14 is a high barrier layer which includes of a blend of EVOH and nylon. Layer 13 represents a tie resin layer useful in adhering layer 14 to layer 11.

The film structures of the present invention are biaxially oriented. In particular, the film structures of the present invention are oriented in the longitudinal or “machine direction” (MD) of the film prior to step (b) and in the lateral or “transverse direction” (TD) of the film prior to step (d). Biaxial oriented films tend to be stiffer and stronger, and also exhibit much better resistance to flexing and folding forces, leading to greater utility and packaging applications.

Biaxial orientation can be conducted simultaneously in both directions, however, most biaxial orientation processes use apparatus which stretches the film sequentially, first in one direction and then in the other. A typical apparatus will stretch a film in the machine direction first and then in the transverse direction. The degree to which a film can be stretched is dependent upon factors including, for example, the polymer from which a film is made. For further discussion concerning biorientation of polyethylene films, see U.S. application Ser. Nos. 08/715,546 and 08/940,261 which are both incorporated herein by reference for all that they disclose.

Usually, the sheet is oriented sequentially, preferably being first stretched in the MD and then stretched in the TID. Thus, the cast material is typically heated (optionally including a pre-heating stage) to its orientation temperature and subjected to MD orientation between two sets of rolls, the second set rotating at a greater speed than the first by an amount effective to obtain the desired draw ratio. Then, the monoaxially oriented sheet is oriented in the TD by heating (again optionally including pre-heating) the sheet as it is fed through an oven and subjected to transverse stretching in a tenter frame. Alternative stretching methods are possible, including employing apparatus capable of simultaneous stretching, or stretching sequentially first in the TD and then in the MD. It is known that these methods often suffer from serious technical limitations rendering them impractical or overly expensive.

A film structure according to the present invention is made primarily from a polyolefin and can be stretched to a relatively high degree. In particular, a film structure according to a method of the present invention is stretched in the machine direction to a degree of from about 4:1 to about 7:1 and in the transverse direction to a degree from about 5:1 to about 12:1. Nevertheless, as a general rule with the film of this invention, the higher the degree of stretch in both the MD and the TD, the better the gloss and haze is in the resulting film. The temperature at which a film is oriented (“stretch temperature”) can also influence the haze, gloss and sealability properties of the resulting film.

The biaxial orientation of the film structures of the present invention, including any preheating step as well as the stretching steps, are performed using stretch temperatures in the range of from about the glass transition temperature (Tg) of the polyolefin to above the crystalline melting point (Tm) of the polyolefin. More specifically, orientation in the MD is conducted at from about 200° F. to about 320° F., more preferably from about 230° F. to about 295° F. Orientation in the TD is conducted at from about 230° F. to about 350° F., more preferably from about 240° F. to about 320° F. The skilled artisan will understand that the orientation temperature employed in a particular situation will generally depend upon the residence time of the base sheet and the size of the rolls. Apparatus temperature higher than the Tm of the polyolefin sheet can be appropriate if the residence time is short. The skilled artisan also understands that the temperatures involved in these processes are in relation to the measured or set temperatures of the equipment rather than the temperature of the polyolefin itself, which generally cannot be directly measured.

The film structures of the present invention can be surface treated with conventional methods to improve wettability of the film and ink receptivity.

The film structures of the present invention are useful in numerous applications including food packaging and in particular, in food packaging where superior barrier characteristics are desired. These characteristics make them advantageous for use in cigarette pack inner liners, as over wrap for butter, chocolate, candy, etc., and as twistwrap.

The following examples are provided to assist in further understanding the invention. The particular materials and conditions employed are intended to be further illustrative of the invention and are not limiting upon the reasonable scope thereof.

### EXAMPLE 1

In this example, the multilayer film structure of the present invention is made by extrusion coating. An extrusion coated biaxially oriented film structure was prepared having a polyolefin core layer of Fina 3371 with an outer heat sealable layer of Fina 9421 containing a coating of 2300 ppm Shin-Etsu 1186 and 1000 ppm Sylbloc 44. A tie resin layer of Mitsui 7911 was coextruded on the core layer on the side opposite the heat sealable layer. A high barrier layer having a blend of 70% by weight Eval® G156B EVOH and 30% by weight PAUX-2034 nylon was extrusion coated on the tie resin layer of the film structure. The resulting film structure had a thickness of 0.70 mil.

The resulting film structure was vacuum metallized onto the high barrier layer with a layer of aluminum. The resulting multilayer film structure had excellent barrier characteristics as illustrated in Table 1 below.

TABLE 1

| | | | Metal Pick Off |
|---|---|---|---|
| | OTR¹ | WVTR² | (%) |
| Multilayer Film Structure³ | 4.72 | 0.44 | N/A |
| Multilayer Film Structure³ + | 0.0206 | 0.017 | 0.00 |
| aluminum layer | | | |

¹OTR is oxygen transmission rate measured in cc/100 in²/24 hrs. at 75° F., 0% relative humidity.
²WVTR is Water Vapor Transmission Rate measured in g/100 in²/24 hrs. at 100° F., 90% relative humidity.
³Film structure has layers 10, 11, 13 and 14 of FIG. 1.

It is readily apparent from Table 1 that by vacuum depositing an aluminum layer to a film structure having layers 10, 11, 13 and 14 as shown in FIG. 1, the barrier characteristics improved significantly. Specifically, the barrier characteristics increased by more than two orders of magnitude for the oxygen transmission rate (OTR) and more than twenty-fold for the water vapor transmission rate (WVTR)

At the same time, the metallized film structure also exhibited excellent metal adhesion as shown by the percentage of metal pick off, 0.00%. Additionally, the above film structure showed thermal stability, reduced gels, high stretch range and low die build-up. The time between die lip cleaning increased from less than 1 hour to greater than 8 hours.

### EXAMPLE 2

In this example, the multilayer film structure of the present invention was made by coextrusion. A base structure was formed by coextruding the four layers shown in FIG. 1 herein and biaxially orienting the resulting structure. The polyolefin core layer included Fina 3371, the outer heat sealable layer included Fina 9421 containing a loading of 2300 ppm Shin-Etsu 1186 and 1000 ppm Sylobloc 44, as in Example 1, the tie resin layer included Mitsui 7911, and the high barrier layer included a blend of 70% by weight EVAL® G156B EVOH and 30% by weight PAUX-2034 nylon, all of which are commercially available. The thickness of the resulting film structure was 0.70 mil. The resulting film structure was vacuum metallized with aluminum onto the high barrier layer.

The resulting multilayer film structure had excellent barrier and fitness for make properties as shown in Table 2 below.

TABLE 2

| | | | Metal Pick Off |
|---|---|---|---|
| | OTR¹ | WVTR² | (%) |
| Multilayer Film Structure³ | 21.02 | 0.54 | N/A |
| Multilayer Film Structure³ + | 0.0560 | 0.017 | 0.00 |
| aluminum layer | | | |

¹OTR is oxygen transmission rate measured in cc/100 in²/24 hrs. at 75° F., 0% relative humidity.
²WVTR is Water Vapor Transmission Rate measured in g/100 in²/24 hrs. at 100° F., 90% relative humidity.
³Film structure has layers 10, 11, 13 and 14 of FIG. 1

It is readily apparent from Table 2 that by attaching an aluminum layer to a film structure having layers 10, 11, 13 and 14 as shown in FIG. 1, the barrier characteristics improved significantly. Specifically, the barrier characteristics increased by more than nine orders of magnitude for the OTR and more than thirty-fold for the WVTR.

At the same time, the metallized film structure also exhibited excellent metal adhesion as shown by the percentage of metal pick off, 0.00%. Additionally, the above film structure showed thermal stability, reduced gels, high stretch range and low die build-up. The time between die lip cleaning increased from less than 1 hour to greater than 8 hours.

### EXAMPLE 3

In this Example, the biaxially oriented multilayer film structure of the present invention is made by coextrusion. A biaxially oriented film structure was prepared having a polyolefin core layer of Fina 3371 (Lyondell 6211 can also be used) with an outer heat sealable layer including Chisso 7823 containing 2300 ppm Tospearl 130 and 1000 ppm Sylobloc 44. A tie resin layer of Mitsui 7911 was coextruded on the core layer on the side opposite the heat sealable layer. A high barrier layer having a blend of 80% by weight Vinex ® 2000 Series PVOH and 20% by weight PAUX-2034 nylon was coextruded on the tie resin layer of the previously assembled film structure. The resulting film structure was vacuum metallized with aluminum onto the high barrier layer. The total thickness of the resulting film structure was 0.70 mil. The resulting multilayer film structure had excellent barrier characteristics as shown in Table 3 below.

TABLE 3

| | | | Metal Pick Off |
|---|---|---|---|
| | OTR¹ | WVTR² | (%) |
| Multilayer Film Structure³ | 5.61 | 0.44 | — |
| Multilayer Film Structure³ + | 0.03 | 0.06 | 0.00 |
| aluminum layer | | | |

¹OTR is oxygen transmission rate measured in cc/100 in²/24 hrs. at 75° F., 0% relative humidity.
²WVTR is Water Vapor Transmission Rate measured in g/100 in²/24 hrs. at 100° F., 90% relative humidity.
³Film structure has layers 10, 11, 13 and 14 of FIG. 1

It is readily apparent from Table 3 that by attaching an aluminum layer to a film structure having layers 10, 11, 13 and 14 as shown in FIG. 1, the barrier characteristics improved significantly. Specifically, the barrier characteristics improved by more than two orders of magnitude for OTR and more than seven times for WVTR.

At the same time, the metallized film structure also exhibited excellent metal adhesion as shown by the percentage of metal pick off, 0.00%. Additionally, the above film structure showed thermal stability, reduced gels, high stretch range and low die build-up.

### EXAMPLE 4

In this Example, the multilayer film structure of the present invention was made by extrusion coating. A base structure was formed by having the first three layers shown in FIG. 1 herein. The polyolefin core layer included Fina 3371 (Lyondell 6211 can also be used), the outer heat sealable layer included Fina 9421, as in Example 1, and the tie resin used in the tie resin layer was Mitsui 7911, all of which are commercially available. The heat sealable layer of Chisso 7823 contained 2300 ppm Tospearl 130 and 100 ppm Sylobloc 44.

The tie resin layer was corona treated by conventional methods in order to improve the adhesion to the high barrier layer which includes a blend of 70% by weight EVAL® G156B EVOH and 30% by weight PAUX-2034 nylon. The total thickness of the resulting film structure was 0.70 mil. The resulting film structure was vacuum metallized with aluminum onto the high barrier layer. The resulting multilayer film structure had excellent barrier and fitness for make properties as shown in Table 4 below.

TABLE 4

| | | | Metal Pick Off |
|---|---|---|---|
| | OTR¹ | WVTR² | (%) |
| Multilayer Film Structure³ | 10.30 | 0.48 | — |
| Multilayer Film Structure³ + | 0.035 | 0.015 | 0.00 |
| aluminum layer | | | |

¹OTR is oxygen transmission rate measured in cc/100 in²/24 hrs. at 75° F., 0% relative humidity.
²WVTR is Water Vapor Transmission Rate measured in g/100 in²/24 hrs. at 100° F., 90% relative humidity.
³Film structure has layers 10, 11, 13 and 14 of FIG. 1

It is readily apparent from Table 4 that by attaching an aluminum layer to a film structure having layers 10, 11, 13 and 14 as shown in FIG. 1, the barrier characteristics improved significantly. Specifically, the barrier characteristics increased by more than four orders of magnitude for the OTR and more than thirty-fold for the WVTR.

At the same time, the metallized film structure also exhibited excellent metal adhesion as shown by the percentage of metal pick off, 0.00%. Additionally, the above film structure showed thermal stability, reduced gels, high stretch range and low die build-up.

Without being bound by any theory, it is believed that the excellent fitness for make properties of the resulting film structures of Examples 1-4 are due to the low acid range of nylon used in the polymer blend of a high barrier layer.

Thus, while there have been described what are presently believed to be the preferred embodiments of the present invention, those skilled in the art will realize that other and further modifications can be made without departing from the spirit of the invention, and it is intended to include all such modifications and changes as come within the true scope of the claims as set forth herein.

What is claimed is:

1. A multilayer packaging film structure having enhanced barrier and metal adhesion characteristics, comprising:
(a) a polyolefin core layer having a first and second side;
(b) a heat sealable layer adjacent said first side of said core layer and substantially coextensive therewith; and
(c) a high barrier layer adjacent said second side of said core layer and substantially coextensive therewith, said high barrier layer comprising a blend of ethylene vinyl alcohol copolymer and nylon.

2. A multilayer film structure according to claim 1, wherein said heat sealable layer comprises a sealant selected from the group consisting of homopolymers, copolymers, terpolymers and mixtures thereof.

3. A multilayer structure according to claim 1, wherein said heat sealable layer further comprises a non-migrating antiblock and/or a slip agent.

4. A multilayer film structure according to claim 1, wherein said high barrier layer comprises from about 55% by weight to about 70% by weight of ethylene vinyl copolymer and from about 30% by weight to about 45% by weight of nylon.

5. A multilayer film structure according to claim 1, further comprising a polyolefin tie resin layer between said core layer and said high barrier layer.

6. A multilayer film structure according to claim 5, wherein said polyolefin tie resin layer comprises a tie resin selected from the group consisting of anhydride polyolefins; Mitsui 7911; DuPont's Bynel 50E571, Bynel 50E622 and Bynel 3800 Series; Millennium's PX 5518, PX 209 and PX 380; and Uniroyal 3200.

7. A multilayer film structure according to claim 1, further comprising a metallized skin layer adjacent said high barrier layer and substantially coextensive therewith.

8. A method for preparing a heat-sealable multilayer film structure having enhanced barrier and metal adhesion characteristics, comprising:
(a) orienting in the machine direction a coextruded film structure comprising a polyolefin core layer having a first and a second side, a heat sealable layer adjacent said first side of said core layer and substantially coextensive therewith, and a tie resin layer deposited on said second side of said core layer and substantially coextensive therewith;
(b) extrusion coating a high barrier layer on said tie resin layer of said second side of said core layer;
(c) orienting the film structure in the transverse direction; and
(d) metallizing said high barrier layer by vapor deposition or extrusion lamination.

9. A method according to claim 8, wherein said high barrier layer comprises from about 55% by weight to about 70% by weight of ethylene vinyl copolymer and from about 30% by weight to about 45% by weight of nylon.

10. A method according to claim 8, further comprising corona treating said tie resin layer prior to step (b).
